(19) United States
(12) Patent Application Publication
(10) Pub. No.: US 2025/0173541 A1
(43) Pub. Date: May 29, 2025

(54) ENHANCING ACCURACY AND REDUCING HALLUCINATIONS IN GENERATIVE AI OUTPUTS THROUGH CONTEXTUAL INTEGRATION AND MULTI-AI-MODEL INTERACTIONS

(71) Applicant: International Business Machines Corporation, Armonk, NY (US)

(72) Inventors: Blaine H. Dolph, Western Springs, IL (US); Christopher Hay, Great Horkesley (GB); Gennaro Anthony Cuomo, Raleigh, NC (US); Luis Fernando Munoz, Centennial, CO (US); Jeffrey Castellano, New York, NY (US); Stanton Keith Ware, Chicago, IL (US); Valentin Tomici, Craiova (RO)

(21) Appl. No.: 18/522,019

(22) Filed: Nov. 28, 2023

(51) Int. Cl. G06N 3/006

(52) U.S. Cl. CPC G06N 3/006

(57) ABSTRACT

A computer-implemented method, system, and computer program product for leveraging artificial intelligence to improve operations. An artificial intelligence assistant is created to assist a user in leveraging artificial intelligence to service a request from a user. Furthermore, a request is received from the user, where the request is a request to chat with a context. Context refers to experiences that are utilized by the user for interacting (e.g., chatting) with artificial intelligence, which is used to minimize artificial intelligence hallucinations since such context is used by the artificial intelligence model to output a response thereby providing more confidence that the output response of the artificial intelligence model is more accurate. The request is then serviced by leveraging the artificial intelligence using the context. In this manner, artificial intelligence hallucinations are minimized.

### TECHNICAL FIELD

The present disclosure relates generally to artificial intelligence models, and more particularly to enhancing accuracy and reducing hallucinations of generative artificial intelligence (AI) outputs by introducing contextual data through strategic interactions among multiple artificial intelligence models thereby improving the reliability and operational efficiency of such systems.

### BACKGROUND

Artificial intelligence (AI) is the intelligence of machines or software as opposed to the intelligence of humans or animals. AI technology is widely used throughout industry, government, and science. Some high-profile applications include advanced web search engines (e.g., Google® search), recommendation systems (used by YouTube®, Amazon®, and Netflix®), understanding human speech (e.g., Siri® and Alexa®), self-driving cars (e.g., Waymo®), generative or creative tools (e.g., ChatGPT® and AI art), and competing at the highest level in strategic games (e.g., chess and go).

AI is implemented using AI models. An AI model is a program that analyzes datasets to find patterns and make predictions. That is, an AI model is a program or algorithm that relies on training data to recognize patterns and make predictions or decisions.

Today, AI models are used in almost all industries. The complexity of the AI model used in a certain scenario will vary depending on the complexity of the task. Examples of tasks performed by AI models include face recognition, voice assistance, personalized shopping, writing, fraud prevention, and human resource management among many others.

Unfortunately, at times, such AI models create outputs that are nonsensical or altogether inaccurate (e.g., claiming that the James Webb Space Telescope had captured the world's first images of a planet outside our solar system). Such a phenomenon is referred to as “AI hallucination,” where a large language model (LLM)—often a generative AI chatbot or computer vision tool—perceives patterns or objects that are nonexistent or imperceptible to human observers, creating outputs that are nonsensical or altogether inaccurate.

Generally, if a user makes a request of a generative AI tool, they desire an output that appropriately addresses the prompt (i.e., a correct answer to a question). However, sometimes AI algorithms produce outputs that are not based on training data, are incorrectly decoded by the transformer, or do not follow any identifiable pattern. In other words, it “hallucinates” the response.

AI hallucinations may occur due to various factors, including overfitting, training data bias/inaccuracy, and high model complexity.

Unfortunately, there is not currently a means for effectively limiting such misrepresentations.

### SUMMARY

In one embodiment of the present disclosure, a computer-implemented method for leveraging artificial intelligence to improve operations comprises creating an artificial intelligence assistant to assist a user in leveraging artificial intelligence. The method further comprises receiving a request from the user to chat with a context, where the context comprises items that enable experiences that are utilized by the user for interacting with the artificial intelligence. The method additionally comprises servicing the request from the user by the artificial intelligence assistant by leveraging the artificial intelligence using the context.

Additionally, in one embodiment of the present disclosure, the context comprises one or more of the following in the group consisting of: an artificial intelligence model, a task-specific assistant, a document, a document source, a conversation, an image, and an intermediary.

Furthermore, in one embodiment of the present disclosure, the artificial intelligence is leveraged based on a plurality of artificial intelligence models, where the method further comprises receiving factors used to evaluate the plurality of artificial intelligence models to service the request from the user. The method additionally comprises analyzing the plurality of artificial intelligence models based on the received factors. Furthermore, the method comprises ranking the plurality of artificial intelligence models based on the analysis. Additionally, the method comprises selecting the artificial intelligence model out of the plurality of artificial intelligence models by the artificial intelligence assistant based on the ranking of the plurality of artificial intelligence models.

Additionally, in one embodiment of the present disclosure, the method further comprises advising the user to utilize the selected artificial intelligence model to service the request.

Furthermore, in one embodiment of the present disclosure, the method additionally comprises delivering a result of servicing the request by the selected artificial intelligence model to the user.

Additionally, in one embodiment of the present disclosure, the method further comprises monitoring responses of the plurality of artificial intelligence models to prompts. The method additionally comprises analyzing the plurality of artificial intelligence models using the monitored responses of the plurality of artificial intelligence models to prompts based on the received factors.

Furthermore, in one embodiment of the present disclosure, the method additionally comprises creating artificial intelligence prompts for particular enterprises and/or use cases. The method further comprises capturing domain knowledge through the artificial intelligence prompts. Furthermore, the method comprises applying the captured domain knowledge to a plurality of artificial intelligence models.

Other forms of the embodiments of the computer-implemented method described above are in a system and in a computer program product.

Accordingly, embodiments of the present disclosure minimize artificial intelligence hallucinations by introducing context (e.g., task-specific assistant) to improve the output accuracy of the artificial intelligence model.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 illustrates examples of microservices in accordance with an embodiment of the present disclosure;

FIG. 3 is a diagram of the software components used by the sidekick AI to minimize AI hallucinations and leverage multiple artificial intelligence models to improve operations in accordance with an embodiment of the present disclosure;

FIG. 4 illustrates an embodiment of the present disclosure of the hardware configuration of the sidekick AI which is representative of a hardware environment for practicing the present disclosure;

FIG. 5 is a flowchart of a method for minimizing artificial intelligence hallucinations by introducing context to improve output accuracy of the artificial intelligence model in accordance with an embodiment of the present disclosure;

FIG. 6 is a flowchart of a method for delivering targeted artificial intelligence solutions across a variety of use cases in accordance with an embodiment of the present disclosure; and

FIG. 7 is a flowchart of a method for leveraging multiple artificial intelligence models to improve operations in accordance with an embodiment of the present disclosure.

### DETAILED DESCRIPTION

In one embodiment of the present disclosure, a computer-implemented method for leveraging artificial intelligence to improve operations comprises creating an artificial intelligence assistant to assist a user in leveraging artificial intelligence. The method further comprises receiving a request from the user to chat with a context, where the context comprises items that enable experiences that are utilized by the user for interacting with the artificial intelligence. The method additionally comprises servicing the request from the user by the artificial intelligence assistant by leveraging the artificial intelligence using the context.

In this manner, artificial intelligence hallucinations are minimized by introducing context (e.g., task-specific assistant) to improve the output accuracy of the artificial intelligence model.

Additionally, in one embodiment of the present disclosure, the context comprises one or more of the following in the group consisting of: an artificial intelligence model, a task-specific assistant, a document, a document source, a conversation, an image, and an intermediary.

In this manner, various types of context may be introduced to improve the output accuracy of the artificial intelligence model thereby minimizing artificial intelligence hallucinations.

Furthermore, in one embodiment of the present disclosure, the artificial intelligence is leveraged based on a plurality of artificial intelligence models, where the method further comprises receiving factors used to evaluate the plurality of artificial intelligence models to service the request from the user. The method additionally comprises analyzing the plurality of artificial intelligence models based on the received factors. Furthermore, the method comprises ranking the plurality of artificial intelligence models based on the analysis. Additionally, the method comprises selecting the artificial intelligence model out of the plurality of artificial intelligence models by the artificial intelligence assistant based on the ranking of the plurality of artificial intelligence models.

In this manner, the most suitable artificial intelligence model to service the needs of the user is selected by leveraging the innovation in the development and improvement of artificial intelligence models and continuously capturing domain knowledge, such as through prompt sets for particular enterprises and use cases, that are applied to such artificial intelligence models.

Additionally, in one embodiment of the present disclosure, the method further comprises advising the user to utilize the selected artificial intelligence model to service the request.

In this manner, the user is advised to utilize the selected artificial intelligence model to service the request.

Furthermore, in one embodiment of the present disclosure, the method additionally comprises delivering a result of servicing the request by the selected artificial intelligence model to the user.

In this manner, the result of servicing the request by the selected artificial intelligence model is delivered to the user.

Additionally, in one embodiment of the present disclosure, the method further comprises monitoring responses of the plurality of artificial intelligence models to prompts. The method additionally comprises analyzing the plurality of artificial intelligence models using the monitored responses of the plurality of artificial intelligence models to prompts based on the received factors.

In this manner, artificial intelligence models are analyzed using the monitored responses of the artificial intelligence models to the prompts based on the received factors, such as cost, privacy, bias, and a user's role.

Furthermore, in one embodiment of the present disclosure, the method additionally comprises creating artificial intelligence prompts for particular enterprises and/or use cases. The method further comprises capturing domain knowledge through the artificial intelligence prompts. Furthermore, the method comprises applying the captured domain knowledge to a plurality of artificial intelligence models.

In this manner, the latest developed domain knowledge may be applied and utilized by the artificial intelligence models, including the latest developed and improved artificial intelligence models.

Other forms of the embodiments of the computer-implemented method described above are in a system and in a computer program product.

As stated above, AI is implemented using AI models. An AI model is a program that analyzes datasets to find patterns and make predictions. That is, an AI model is a program or algorithm that relies on training data to recognize patterns and make predictions or decisions.

Today, AI models are used in almost all industries. The complexity of the AI model used in a certain scenario will vary depending on the complexity of the task. Examples of tasks performed by AI models include face recognition, voice assistance, personalized shopping, writing, fraud prevention, and human resource management among many others.

Unfortunately, at times, such AI models create outputs that are nonsensical or altogether inaccurate (e.g., claiming that the James Webb Space Telescope had captured the world's first images of a planet outside our solar system). Such a phenomenon is referred to as “AI hallucination,” where a large language model (LLM)—often a generative AI chatbot or computer vision tool—perceives patterns or objects that are nonexistent or imperceptible to human observers, creating outputs that are nonsensical or altogether inaccurate.

Generally, if a user makes a request of a generative AI tool, they desire an output that appropriately addresses the prompt (i.e., a correct answer to a question). However, sometimes AI algorithms produce outputs that are not based on training data, are incorrectly decoded by the transformer, or do not follow any identifiable pattern. In other words, it “hallucinates” the response.

AI hallucinations may occur due to various factors, including overfitting, training data bias/inaccuracy, and high model complexity.

Unfortunately, there is not currently a means for effectively limiting such misrepresentations.

The embodiments of the present disclosure provide a means for minimizing AI hallucinations by introducing context (e.g., task-specific assistant) to improve the output accuracy of the artificial intelligence model. Context, as used herein, refers to items that enable experiences that are utilized by the user for interacting (e.g., chatting) with artificial intelligence, which is used to minimize artificial intelligence hallucinations since such context is used by the artificial intelligence model to output a response thereby providing more confidence that the output response of the artificial intelligence model is more accurate. Examples of context include, but are not limited to, an artificial intelligence model, a task-specific assistant (pre-instruct an artificial intelligence model to elicit a type of response), a document (e.g., ChatDOC), a data source, a conversation, etc. By introducing such context, there is a greater confidence that the output of the artificial intelligence model is more accurate. A further discussion regarding these and other features is provided below.

In some embodiments of the present disclosure, the present disclosure comprises a computer-implemented method, system, and computer program product for leveraging artificial intelligence to improve operations. In one embodiment of the present disclosure, an artificial intelligence assistant is created to assist a user in leveraging artificial intelligence to service a request from a user. An artificial intelligence assistant, as used herein, refers to a application program that understands natural language voice commands and completes tasks for the user. Furthermore, a request is received from the user, where the request is a request to chat with a context. Context, as used herein, refers to items that enable experiences that are utilized by the user for interacting (e.g., chatting) with artificial intelligence, which is used to minimize artificial intelligence hallucinations since such context is used by the artificial intelligence model to output a response thereby providing more confidence that the output response of the artificial intelligence model is more accurate. Examples of context include, but are not limited to, an artificial intelligence model, a task-specific assistant (pre-instruct an artificial intelligence model to elicit a type of response), a document (e.g., ChatDOC), a data source, a conversation, etc. The request is then serviced by leveraging the artificial intelligence using the context. In this manner, artificial intelligence hallucinations are minimized.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

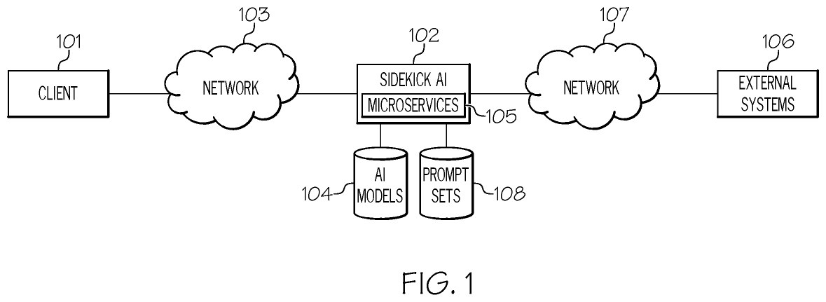

Referring now to the Figures in detail, FIG. 1 illustrates an embodiment of the present disclosure of a communication system 100 for practicing the principles of the present disclosure. Communication system 100 includes a client 101 connected to a component referred to herein as the “sidekick AI” 102 via a network 103.

Client 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance, and the like) configured with the capability of connecting to network 103 and consequently communicating with other clients 101 and sidekick AI 102. It is noted that both computing device 101 and the user of computing device 101 may be identified with element number 101.

Sidekick AI 102 is a system configured to minimize AI hallucinations by introducing context (e.g., task-specific assistant) to improve the output accuracy of the artificial intelligence model. As discussed above, context, as used herein, refers to items that enable experiences that are utilized by the user for interacting (e.g., chatting) with artificial intelligence, which is used to minimize artificial intelligence hallucinations since such context is used by the artificial intelligence model to output a response thereby providing more confidence that the output response of the artificial intelligence model is more accurate. Examples of context include, but are not limited to, an artificial intelligence model, a task-specific assistant (pre-instruct an artificial intelligence model to elicit a type of response), a document (e.g., ChatDOC), a data source, a conversation, etc. By introducing such context, there is a greater confidence that the output of the artificial intelligence model is more accurate.

In one embodiment, sidekick AI 102 leverages the innovation in the development and improvement of artificial intelligence models to select the most suitable artificial intelligence model out of a group of artificial intelligence models to service the needs of the user (e.g., enterprise). In one embodiment, such a group of artificial intelligence models resides in a database 104 connected to sidekick AI 102. Examples of the types of artificial intelligence models include, but are not limited to, linear regression (AI model uses known data to predict the value of unknown data), logistic regression (AI model calculates the values or probabilities of binary equations, which have a “yes” or “no” answer), deep neural network (class of machine learning algorithms that aims to mimic the information processing of the brain), decision trees (AI models used for solving classification and regression problems), random forest (AI model which combines the output of multiple decision trees to reach a single result), Naïve Bayes (AI model that operates on the assumption that the starting inputs in an algorithm have no relationship and is based on the Bayes Theorem for calculating conditional probabilities), K-Nearest Neighbor (KNN) (AI model classifies any data subsequent to the initial data based on how similar it is to the existing data), Linear Discriminant Analysis (LDA) (AI model used for classification purposes), etc.

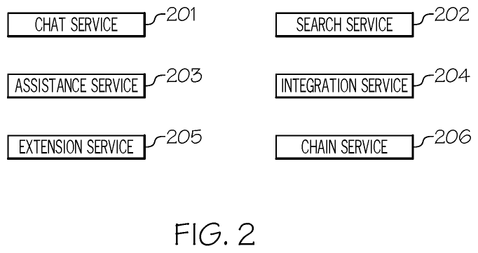

In one embodiment, sidekick AI 102 houses the core services, including microservices 105 that enable various functionality, such as the chat-based interface (discussed further below), search functionality (discussed further below), assistance (discussed further below), integration with external systems (discussed further below), and so forth. A microservice 105, as used herein, refers to a service that is independently deployable. Examples of such microservices 105 are discussed below in connection with FIG. 2.

As shown in FIG. 1, system 100 further includes external systems 106 connected to sidekick AI 102 via a network 107. External systems 106, as used herein, refer to any system that is external to sidekick AI 102 which may include the storage of domain knowledge. In one embodiment, sidekick AI 102 is connected to external systems 106 using adapters that enable seamless data flow between platforms. In such an embodiment, there is greater flexibility in accessing and utilizing data across different systems.

Networks 103, 107 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

Furthermore, as shown in FIG. 1, prompt sets are stored in database 108 connected to sidekick AI 102. A “prompt set,” as used herein, refers to a ready-made, test, and optimized prompt designed to perform specific tasks. For instance, a prompt set may correspond to a collection of domain-specific training data and a prompt. An example of a prompt set may include the prompt of explaining how the theory of relativity works as well as the data to answer such a prompt. A “prompt” (also referred to herein as an “AI prompt”), as used herein, refers to a mode of interaction between a human and a large language model that lets the model generate the intended output. The interaction may be in the form of a question, text, code snippets, or examples.

In one embodiment, sidekick AI 102 utilizes a multi-model (multiple artificial intelligence models) strategy that leverages the innovation in the development and improvement of artificial intelligence models. In one embodiment, such leverage is accomplished via the capture of domain knowledge that is applied to such artificial models, which may correspond to foundation models. That is, such captured domain knowledge is enabled to evolve independently of the underlying foundation models. A foundation model, as used herein, is a large machine learning (ML) model trained on a vast quantity of data at scale such that it can be adapted to a wide range of downstream tasks. As a result, sidekick AI 102 aims to help users stay current with the latest advancement in artificial intelligence model innovation by capturing and applying domain knowledge to such artificial intelligence models as well as continuously advising the best AI and delivering targeted artificial intelligence solutions across a variety of industry use cases, while maintaining an enterprise safe environment.

In one embodiment, sidekick AI 102 offers a range of features, including, but are not limited to, a chat-based interface, prompts, data-set search, assistance, integrations, 3rd party extensions, automations, a benchmarking engine and analytics, an ecosystem of models, and an enterprise safe deployment. These features enable sidekick AI 102 to continuously advise the best AI, capture domain knowledge, and deliver targeted AI solutions across a variety of industry use cases, all while maintaining data privacy and confidentiality.

In one embodiment, sidekick AI 102 utilizes a chat-based interface that allows users (e.g., user of client 101) to ask questions and receive answers from the best available artificial intelligence models for their task. Sidekick AI 102 leverages multiple artificial intelligence models stored in database 104 to provide the most accurate and relevant response. Additionally, sidekick AI 102 enables users to search against their private data for more personalized and specific results (e.g., question and answer against a request for proposal document, an invoice or a bill of material).

In one embodiment, sidekick AI 102 captures domain knowledge based on the creation of prompt sets for particular enterprises and/or use cases. A “prompt set,” as used herein, refers to a ready-made, test, and optimized prompt designed to perform specific tasks. For instance, a prompt set may correspond to a collection of domain-specific training data and a prompt. An example of a prompt set may include the prompt of explaining how the theory of relativity works as well as the data to answer such a prompt. In one embodiment, with access to a catalog of prompts across different roles, sidekick AI 102 enables keeping pace with the rapidly evolving AI landscape, with future-proofing assurance that the knowledge captured is transferable to new generations of models.

In one embodiment, sidekick AI 102 implements data-set search functionality, which enables users to add specific domain knowledge data to the foundation models and reference specific documents that return in the chat result. In one embodiment, such data-set search functionality is achieved via the use of AI embeddings. AI embeddings, are used herein, represent real-world objects (e.g., words, images, videos, etc.) in a form that computers can process, such as numbers. By using AI embeddings, sidekick AI 102 can search and match specific documents or data points against a user's query, providing more accurate and relevant results.

In one embodiment, sidekick AI 102 enables users to create and share new AI assistants across the enterprise that are focused on performing specific tasks. An AI assistant, as used herein, refer to a application program that understands natural language voice commands and completes tasks for the user. In one embodiment, such an AI assistant is used to select an artificial intelligence model that best services a request from the user. Furthermore, in one embodiment, such an AI assistant is used to service a request from the user (e.g. user of client 101) by leveraging the artificial intelligence using the context.

In one embodiment, sidekick AI 102 implements integrations thereby allowing users (e.g., user of client 101) to connect to external systems 106, such as by using adapters that enable seamless data flow between platforms. As a result, greater flexibility is realized in accessing and utilizing data across different systems.

In one embodiment, sidekick AI 102 provides native integrations to AI models and prompts, such as directly from tools utilized by the users (e.g., user of client 101), such as VSCode®, Slack, or Jira®. As a result, AI capabilities are seamlessly integrated into the user's workflows and tools.

In one embodiment, sidekick AI 102 implements a drag-and-drop interface that allows users (e.g., user of client 101) to create automation from chained prompts. A “chained prompt,” as used herein, refers to compatible prompt snippets that are snapped together to build AI-powered solutions. Such a feature empowers users (e.g., user of client 101) to quickly and easily create customized solutions tailored to their specific needs thereby improving their efficiency and productivity. A “prompt” (also referred to herein as an “AI prompt”), as used herein, refers to a mode of interaction between a human and a large language model that lets the model generate the intended output. The interaction may be in the form of a question, text, code snippets, or examples. A “prompt snippet,” as used herein, refers to a piece or extract of a prompt.

In one embodiment, sidekick AI 102 delivers the results of servicing a request from a user (e.g., user of client 101) by an artificial intelligence model selected by sidekick AI 102 in an enterprise safe environment.

In one embodiment, sidekick AI 102 captures domain knowledge, such as through prompt sets for particular enterprises and use cases. Domain knowledge, as used herein, refers to the knowledge of a specific, specialized discipline or field. In one embodiment, such captured domain knowledge may then be applied to artificial intelligence models stored in database 104, including both new and improved artificial intelligence models, to ensure that such artificial intelligence models recognize patterns and make predictions or decisions using the latest domain knowledge in order to deliver the best targeted artificial intelligence solutions across a variety of use cases.

Furthermore, in one embodiment, sidekick AI 102 receives factors from a user (e.g., user of client 101) to evaluate the artificial intelligence models stored in database 104 to service a request from the user, where such factors may include cost, privacy, bias, and a user's role.

In one embodiment, sidekick AI 102 analyzes the artificial intelligence models based on the received factors, which are then ranked based on such analysis as to which artificial intelligence model most effectively services requests based on the user provided factors.

In one embodiment, sidekick AI 102 selects a specific artificial intelligence model based on the ranking, which corresponds to the most appropriate artificial intelligence model to service the user's request.

In one embodiment, sidekick AI 102 delivers the results of servicing the request by the selected artificial intelligence model to the user (e.g., user of client 101) in an enterprise safe environment.

In one embodiment, sidekick AI 102 facilitates engagement with artificial intelligence models stored in database 104.

In one embodiment, sidekick AI 102 utilizes natural language dialogue. By utilizing natural language dialogue, it enables a variety of applications, such as question and answer, content generation, and data retrieval.

In one embodiment, sidekick AI 102 provides prompts which serve as the mechanism to facilitate interactives with generative artificial intelligence (artificial intelligence capable of generating text, images, or other media).

In one embodiment, sidekick AI 102 offers default access to watsonx.ai models.

Furthermore, in one embodiment, sidekick AI 102 offers a suite of features for enterprise use, including, but are not limited to, versatile chat experience, crowd-sourced prompting, flexible model access, security measures, and extensibility options. For example, such security measures may include role-based or task-based access limitations.

In one embodiment, sidekick AI 102 provides a chat experience tailored to specific tasks, roles, or outcomes.

In one embodiment, sidekick AI 102 includes the ability to chat with various Internet and Intranet content.

In one embodiment, sidekick AI 102 introduces versatile chat experiences which provide context for minimizing artificial intelligence hallucinations. For example, one such chat experience involves chatting with an artificial intelligence model out of the artificial intelligence models stored in database 104. As discussed above, sidekick AI 102 offers default access to watsonx.ai models. Furthermore, sidekick AI 102 allows engagement with third-party and ecosystem models. Such flexibility enables access to both wastonx.ai models and other specialized models as the client needs dictate.

In another example, a chat experience may involve chatting with task-specific assistants. As previously discussed, such task-specific assistants pre-instruct an artificial intelligence model to elicit a type of response. For example, the assistant may pre-instruct an artificial intelligence model out of the artificial intelligence models stored in database 104 to automatically provide the weather forecast for the next four hours in the city of Yorktown Heights. Such task-specific assistants provide a chat experience tailored to specific tasks, roles, or outcomes. For instance, a design chat-assistant ensures that the responses align with company guidelines; whereas, a code-review assistant may follow team-specific coding standards.

In a further example, a chat experience may involve chatting with documents. For instance, sidekick AI 102 may use the retrieval augmented generation (RAG) technique to compile document collections (e.g., PDFs, DOCs, etc.) for focused chat sessions. These collections can summarize presentations, technical papers, and requirements. The scope of such collections may be user-specific, team-specific, or contributed to a global repository for organizational use. In one embodiment, such a chat experience with documents enables users to quickly extract, locate, and summarize information, such as via ChatDOC.

In another example, a chat experience may involve chatting with data sources. Such a feature includes the ability to chat with various Internet and Intranet content, ranging from weather and stock market feeds to Google® search and Wikipeida® through application programming interfaces.

Other examples of context (chat experience) include a previous conversation, an intermediary (e.g., virtual assistant), etc.

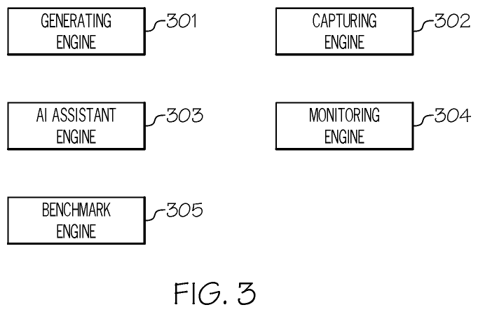

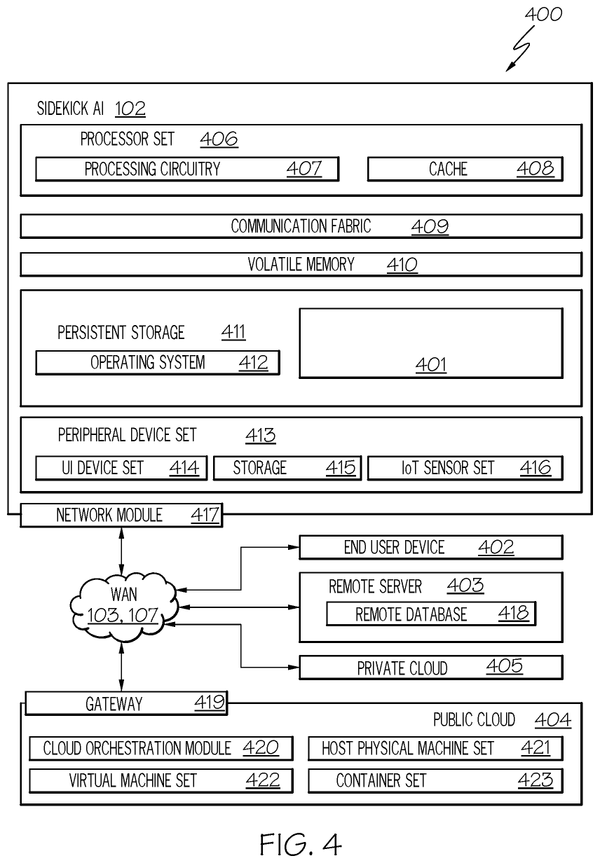

A description of the software components of sidekick AI 102 used for minimizing AI hallucinations and leveraging multiple artificial intelligence models to improve operations is provided below in connection with FIG. 3. A description of the hardware configuration of sidekick AI 102 is provided further below in connection with FIG. 4.

System 100 is not to be limited in scope to any one particular network architecture. System 100 may include any number of clients 101, sidekick AIs 102, networks 103, 107, databases 104, 108, and external systems 106.

As discussed above, sidekick AI 102 includes microservices 105 which enable various functionality, such as the chat-based interface (discussed further below), search functionality (discussed further below), assistance (discussed further below), integration with external systems (discussed further below), and so forth. Examples of such microservices 105 are discussed below in connection with FIG. 2.

Referring to FIG. 2, FIG. 2 illustrates examples of microservices 105 in accordance with an embodiment of the present disclosure.

As shown in FIG. 2, microservices 105 include a chat service 201 configured to provide a chat-based interface for users (e.g., user of client 101) to ask questions and receive answers from Sidekick AI's foundation models stored in database 104. In one embodiment, chat service 201 implements the chat feature, which enables users to issue and receive accurate and relevant responses through the chat-based interface.

Microservices 105 further includes a search service 202 which enables users (e.g., user of client 101) to add specific domain knowledge data to the foundation models and reference specific documents that return in the chat result. In one embodiment, such functionality is achieved via the use of AI embeddings. AI embeddings, are used herein, represent real-world objects (e.g., words, images, videos, etc.) in a form that computers can process, such as numbers. By using AI embeddings, sidekick AI 102 can search and match specific documents or data points against a user's query, providing more accurate and relevant results.

Microservices 105 additionally includes an assistance service 203 which enables users (e.g., user of client 101) to create and share new artificial intelligence assistants across the enterprise that are focused on performing specific tasks. By leveraging a unique foundation model stored in database 104, users gain access to an artificial intelligence assistant that possesses knowledge across various disciplines enabling them to make more informed decisions and provide more comprehensive solutions.

Furthermore, microservices 105 include an integration service 204 which enables users (e.g., user of client 101) to connect to external systems 106, such as by using adapters that enable seamless data flow between platforms. In such an embodiment, there is greater flexibility in accessing and utilizing data across different systems.

Additionally, microservices 105 include an extension service 205 which provides native integrations to AI models and artificial intelligence prompts, such as directly from tools utilized by the users (e.g., user of client 101), such as VSCode®, Slack, or Jira®. As a result, AI capabilities are seamlessly integrated into the user's workflows and tools.

Microservices 105 further include a chain service 206 which enables users (e.g., user of client 101) to create automation from chained prompts allowing compatible prompt snippets to be snapped together to build AI-powered solutions without extensive coding or development. A “chained prompt,” as used herein, refers to compatible prompt snippets that are snapped together to build AI-powered solutions. A “prompt” (also referred to herein as an “AI prompt”), as used herein, refers to a mode of interaction between a human and a large language model that lets the model generate the intended output. The interaction may be in the form of a question, text, code snippets, or examples. A “prompt snippet,” as used herein, refers to a piece or extract of a prompt.

A discussion regarding the software components used by sidekick AI 102 to minimize AI hallucinations and leverage multiple artificial intelligence models to improve operations is provided below in connection with FIG. 3.

FIG. 3 is a diagram of the software components used by sidekick AI 102 to minimize AI hallucinations and leverage multiple artificial intelligence models to improve operations in accordance with an embodiment of the present disclosure.

Referring to FIG. 3, in conjunction with FIGS. 1-2, sidekick AI 102 includes a generating engine 301 configured to create AI prompts for particular enterprises and use cases. A “prompt” (also referred to herein as an “AI prompt”), as used herein, refers to a mode of interaction between a human and a large language model that lets the model generate the intended output. The interaction may be in the form of a question, text, code snippets, or examples.

In one embodiment, generating engine 301 receives an identification of the enterprise or use case for which to create an AI prompt from the user of sidekick AI 102. In one embodiment, generating engine 301 utilizes an AI prompt generator tool to suggest AI prompts based on inputs provided by generating engine 301. In one embodiment, such inputs correspond to categories of knowledge (e.g., theory of relativity), which are used by the AI prompt generator to generate AI prompts. In one embodiment, such categories of knowledge are extracted by generating engine 301 from a data structure (e.g., table) that includes a listing of the categories of knowledge and corresponding enterprises and use cases. Based on the identification of an enterprise or use case received by generating engine 301, generating engine 301 uses such an identification to identify the corresponding category of knowledge in the data structure. In one embodiment, such a data structure resides within the storage device of sidekick AI 102. In one embodiment, such a data structure is populated by an expert.

In one embodiment, generating engine 301 may utilizes various AI prompt generator tools to create AI prompts for particular enterprises and use cases, which may include, but are not limited to, AI Prompt Generator, PromtoMania, PromptPerfect, PromptHero, PromptBase, etc.

Furthermore, in one embodiment, sidekick AI 102 includes capturing engine 302 configured to capture domain knowledge through AI prompts thereby creating prompt sets. Domain knowledge, as used herein, refers to the knowledge of a specific, specialized discipline or field. A “prompt set,” as used herein, refers to a ready-made, test, and optimized prompt designed to perform specific tasks. For instance, a prompt set may correspond to a collection of domain knowledge and a prompt. An example of a prompt set may include the prompt of explaining how the theory of relativity works as well as the data to answer such a prompt.

In one embodiment, capturing engine 302 performs a search in external systems 106, such as via network 107, which contain domain knowledge. External systems 106, as used herein, refer to any system that is external to sidekick AI 102 which may include the storage of domain knowledge. In one embodiment, such a search is performed in external systems 106 by utilizing a search engine (e.g., Google®, Openverse®, Bing®, Yahoo®, etc.) based on the AI prompt (e.g., how does the theory of relativity work).

In one embodiment, such domain knowledge that is identified via the search engine is captured and appended to the appropriate AI prompt. The captured domain knowledge and the associated AI prompt are combined to form the prompt set, which is stored in database 108.

In one embodiment, the search engine utilized by capturing engine 302 includes a spider (program run by the search engine) to build a summary of a website's content. Spiders create a text-based summary of content and an address (URL) for each webpage. In one embodiment, based on the text-based summary of the content, the search engine and/or capturing engine 302 uses natural language processing to determine if the text-based summary of the content of the webpage is pertinent to the AI prompt (e.g., how does the theory of relativity work). If the text-based summary of the content of the webpage is pertinent to the AI prompt, then the content of the webpage is captured as domain knowledge.

In one embodiment, such a determination is performed based on evaluating the similarity of the AI prompt to the text-based summary of the content of the webpage. In one embodiment, such similarity between the text-based summary of the content of the webpage and the AI prompt is determined by vectorizing the text-based summary of the content of the webpage and the AI prompt, such as via Word2vec, Doc2Vec, GloVe, etc. After being converted into real-valued vectors, a similarity measure, such as cosine similarity or the Euclidean distance, may be used to determine the similarity between the text-based summary of the content of the webpage and the AI prompt. Such a similarity measure is compared to a threshold value, which may be user-designated, to determine if the text-based summary of the content of the webpage is within a threshold degree of similarity, which may be user-designated, to the AI prompt. If the similarity measure exceeds such a threshold value, then the text-based summary of the content of the webpage and the AI prompt are deemed to be within a threshold degree of similarity and the content of the webpage is captured as domain knowledge. Otherwise, the text-based summary of the content of the webpage and the AI prompt are not deemed to be within the threshold degree of similarity and the content of the webpage is not captured as domain knowledge.

“Cosine similarity,” as used herein, refers to a measure of similarity between two non-zero vectors defined in an inner product space. Cosine similarity is the cosine of the angle between the vectors. That is, it is the dot product of the vectors divided by the product of their lengths. If the measurement exceeds a threshold value, which may be user-designated, then the text-based summary of the content of the webpage and the AI prompt are deemed to be within a threshold degree of similarity and the content of the webpage is captured as domain knowledge. Otherwise, the text-based summary of the content of the webpage and the AI prompt are not deemed to be within the threshold degree of similarity and the content of the webpage is not captured as domain knowledge.

In one embodiment, the Euclidean distance is calculated as the square root of the sum of the squared differences between the two feature vectors. If the distance exceeds a threshold value, which may be user-designated, then the text-based summary of the content of the webpage and the AI prompt are deemed to be within a threshold degree of similarity and the content of the webpage is captured as domain knowledge. Otherwise, the text-based summary of the content of the webpage and the AI prompt are not deemed to be within the threshold degree of similarity and the content of the webpage is not captured as domain knowledge.

In one embodiment, the similarity measure is a score between the values of 0 and 1 for vectors that have only positive values. In one embodiment, any negative scores can be made positive by taking its absolute value.

Capturing engine 302 utilizes various software tools for generating the similarity score, which can include, but are not limited to, TensorFlow®, Math Works®, plus sklearn, scikit-Learn®, etc.

In one embodiment, capturing engine 302 applies the captured domain knowledge to the artificial intelligence models, such as the artificial intelligence models stored in database 104. In one embodiment, such captured domain knowledge is applied to the artificial intelligence models to ensure that such artificial intelligence models recognize patterns and make predictions or decisions utilizing such domain knowledge in order to deliver targeted artificial intelligence solutions across a variety of use cases.

In one embodiment, “applying” involves training and evaluating the artificial intelligence models using such captured domain knowledge. In one embodiment, such captured domain knowledge corresponds to problem-specific information that can change the input data, the loss-function, or the parameters.

By applying the captured domain knowledge to the artificial intelligence models, such models leverage the latest available knowledge. Furthermore, the artificial intelligence models that are stored in database 104 are constantly updated to ensure that the latest development and improvement of artificial intelligence models are reflected in the artificial intelligence models stored in database 104. Hence, the latest developed and improved artificial intelligence models stored in database 104 can leverage the latest available domain knowledge.

Sidekick AI 102 further includes an artificial intelligence (AI) assistant engine 303 configured to create an artificial intelligence assistant to select an artificial intelligence model to service a request from a user (e.g., user of client 101) and/or to service the request from the user (e.g., user of client 101) by leveraging the artificial intelligence using context. An artificial intelligence assistant, as used herein, refers to a application program that understands natural language voice commands and completes tasks for the user.

In one embodiment, AI assistant engine 303 creates an artificial intelligence assistant by selecting a base model, developing prompts, and integrating AI history. The base model serves as the foundation for the artificial intelligence assistant and determines its core capabilities. In one embodiment, a list of various base models associated with objectives and tasks to be performed is stored in a data structure (e.g., table), which may reside within the storage device of sidekick AI 102. Based on identifying the objectives and tasks to be performed, which may be provided by the user (e.g., user of client 101), AI assistant engine 303 identifies the appropriate base model from the data structure discussed above. In one embodiment, such a data structure is populated by an expert.

In one embodiment, prompts guide the artificial intelligence assistant's interactions with users. Such prompts are designed to elicit meaningful responses from the artificial intelligence assistant. In one embodiment, such prompts are generated by generating engine 301 as discussed above. For example, generating engine 301 may utilize an AI prompt generator tool to suggest AI prompts based on inputs provided by generating engine 301. In one embodiment, such inputs correspond to categories of knowledge (e.g., theory of relativity), which are used by the AI prompt generator to generate AI prompts. In one embodiment, such categories of knowledge are extracted by generating engine 301 from a data structure (e.g., table) that includes a listing of the categories of knowledge and corresponding enterprises and use cases. Based on the identification of an enterprise or use case received by generating engine 301, generating engine 301 uses such an identification to identify the corresponding category of knowledge in the data structure. In one embodiment, such a data structure resides within the storage device of sidekick AI 102. In one embodiment, such a data structure is populated by an expert.

In one embodiment, AI assistant engine 303 integrates AI history and context sources, which may be stored in database 104, 108. In one embodiment, such sources form the knowledge base of the artificial intelligence assistant, providing it with vital background information, thereby enhancing the artificial intelligence assistant's ability to respond effectively.

In one embodiment, such an artificial intelligence assistant is used to select an artificial intelligence model that best services a request from the user after the artificial intelligence models stored in database 104 have been ranked based, at least in part, on the factors provided by the user (e.g., user of client 101) as discussed below.

Furthermore, sidekick AI 102 includes a monitoring engine 304 configured to monitor the response of the artificial intelligence models stored in database 104 to prompts. In one embodiment, such prompts correspond to the prompts of the prompt sets stored in database 108. In one embodiment, such artificial intelligence models stored in database 104 correspond to the latest developed and improved artificial intelligence models that can leverage the latest available domain knowledge.

In one embodiment, monitoring engine 304 monitors the response of the artificial intelligence models stored in database 104 to prompts based on tracking metrics, such as accuracy, precision, recall, and F1-score, to evaluate the model performance. By monitoring or tracking such metrics, changes in the model behavior, potential drift, or degradation in performance can be detected.

In one embodiment, monitoring engine 304 monitors the response of the artificial intelligence models stored in database 104 to prompts by tracking data distribution shifts, performance shifts, system performance (e.g., usage of CPU, memory, disk, and network I/O), performance by segment (allows one to find critical areas, such as where the machine learning model makes mistakes and where it performs the best), bias/fairness (ensuring that all sub-groups and track compliances have received fair treatment), etc.

In one embodiment, monitoring engine 304 utilizes various software tools for monitoring the response of the artificial intelligence models stored in database 104 to prompts (e.g., prompt of explaining how the theory of relativity works), such as, but are not limited to, Lakehouse Monitoring, Valohai, MetricFire®, Qwak, etc.

Sidekick AI 102 additionally includes benchmark engine 305 configured to receive factors from a user, such as the user of client 101, which are used to evaluate the artificial intelligence models stored in database 104 to service a request from the user. Examples of such a request include, but are not limited to, identifying opportunities for services, optimizing the structure of a complex service system, optimizing the operation of a service system, identifying an operational risk, identifying a fault, identifying a potential causality, etc.

In one embodiment, such factors provided by the user (e.g., enterprise, individual) correspond to important metrics that need to be minimized or maximized. Examples of metrics include cost, privacy, bias, and a user's role. Cost, as used herein, refers to the total cost of implementing the artificial intelligence model to service the user's request, including the hardware cost (e.g., computational power, data storage, etc.) as well as the software cost (e.g., analysis, processing, etc.) for running the artificial intelligence algorithm. In one embodiment, such information for servicing various requests is stored in a data structure (e.g., table) residing within the storage device of sidekick AI 102. In one embodiment, in addition to providing the factors, the user provides benchmark engine 305 the request to be serviced. Upon receipt of the request to be serviced, benchmark engine 305 identifies cost information stored in the data structure discussed above that is associated with such a request. In one embodiment, such a data structure is populated by an expert.

Privacy, as used herein, refers to the risk of data leakage. In one embodiment, benchmark engine 305 evaluates the risk of data leakage for each artificial intelligence model using a privacy impact assessment. In one embodiment, such an assessment is performed by using a privacy loss parameter that is used to measure how much an output changes when data is added or removed.

In one embodiment, benchmark engine 305 determines the probability of data leakage in the artificial intelligence model based on the Bayesian inference to produce a thorough approach to calculate the reverse probability of unseen variables in order to make statistical conclusions about the relevant correlated variables and to calculate accordingly a lower limit on the marginal likelihood of the observed variables being derived from a coupling method. A higher marginal probability for a set of variables suggests a better fit of the data and thus a greater likelihood of a data leak in the artificial intelligence model.

Bias, as used herein, refers to erroneous assumptions in the machine learning process that produce erroneous results. In one embodiment, benchmark engine 305 detects bias for each artificial intelligence model stored in database 104 by looking at the disparate impact of model outcome across different population subsets. Benchmark engine 305 may utilize various software tools for detecting bias including, but are not limited to, Audit AI, AI Fairness 360, Skater, etc.

The user's role, as used herein, refers to a predefined category that is assigned to users based on various criteria, which may be established by sidekick AI 102. Examples of such roles include data service, environment maker, basic user, system administrator, etc. In one embodiment, the user determines its role from a catalog of roles provided by sidekick AI 102, such as via a drop-down menu. In one embodiment, the user (e.g., user of client 101) makes a selection of its role via the graphical user interface of client 101.

In one embodiment, benchmark engine 305 analyzes the artificial intelligence models stored in database 104 using the monitored responses of the artificial intelligence models to the prompts based on the received factors.

In one embodiment, based on the monitored responses of the artificial intelligence models to the prompts, such monitored responses of the artificial intelligence models are compared to metrics established by the received factors. For example, the responses of the artificial intelligence models concerning system performance (e.g., usage of CPU, memory, disk, and network I/O) may be compared amongst each other by benchmark engine 305 to determine which has a cost advantage (i.e., which artificial intelligence model has the lowest cost in terms of system usage). In another example, the responses of the artificial intelligence models concerning system performance may be evaluated by benchmark engine 305 based on detecting bias by looking at the disparate impact of model outcome across different population subsets. In another example, the responses of the artificial intelligence models concerning the risk of data leakage may be evaluated by benchmark engine 305 based on implementing a privacy impact assessment, such as by using a privacy loss parameter to measure how much an output changes when data is added or removed.

In another example, the artificial intelligence models stored in database 104 may be analyzed based on the user's role, In one embodiment, certain artificial intelligence models are better able to service certain roles than other artificial intelligence models. In one embodiment, the ability of certain artificial intelligence models, such as the artificial intelligence models stored in database 104, to service various roles is identified from a data structure (e.g., table), which may reside within the storage device of sidekick AI 102. In one embodiment, such abilities to service various roles are identified from the data structure by benchmark engine 305 based on values associated with the role and corresponding artificial intelligence model. In one embodiment, the higher the value, the greater the ability of the artificial intelligence model to service such a role and vice-versa. In one embodiment, such a data structure is populated by an expert.

In one embodiment, benchmark engine 305 ranks the artificial intelligence models stored in database 104 based on the analysis, such as ranking the artificial intelligence models from being the best performer in terms of satisfying the factors provided by the user to the greatest extent (e.g., minimizing the cost, maximizing privacy, minimizing bias, etc.).

In one embodiment, benchmark engine 305 ranks the artificial intelligence models in terms of satisfying the factors provided by the user to the greatest extent using various software tools including, but are not limited to, Fiddler®, Arize®, Amazon SageMaker®, etc.

Upon ranking the artificial intelligence models that are stored in database 104 in terms of satisfying the factors provided by the user to the greatest extent, the artificial intelligence model that is ranked the highest is selected by the artificial intelligence assistant discussed above.

In one embodiment, the artificial intelligence assistant may then advise the user (e.g., user of client 101) to utilize the selected artificial intelligence model to service the request. In one embodiment, the artificial intelligence assistant may advise the user via the graphical user interface of client 101.

In one embodiment, the user may be prompted via the graphical user interface of client 101 as to whether the user agrees to utilize the selected artificial intelligence model. For example, graphical representations (e.g., yes or no buttons) may be presented to the user on the graphical user interface of client 101.

If the user indicates to utilize the selected artificial intelligence model (e.g., user selects the yes button on the graphical user interface of client 101), then, in one embodiment, the artificial intelligence assistant has the selected artificial intelligence model service the user's request upon receipt of the user's request, which may be received directly from the user or from benchmark engine 305. Upon servicing the user's request by the selected artificial intelligence model, the artificial intelligence assistant delivers the result of servicing the request by the selected artificial intelligence model to the user.

A further description of these and other features is provided below in connection with the discussion of the method for minimizing AI hallucinations and leveraging multiple artificial intelligence models to improve operations.

Prior to the discussion of the method for minimizing AI hallucinations and leveraging multiple artificial intelligence models to improve operations, a description of the hardware configuration of sidekick AI 102 (FIG. 1) is provided below in connection with FIG. 4.

Referring now to FIG. 4, in conjunction with FIG. 1, FIG. 4 illustrates an embodiment of the present disclosure of the hardware configuration of sidekick AI 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code (computer code for generating ideation scenarios based on intents associated with requirements, which is stored in block 401) involved in performing the disclosed methods, such as minimizing AI hallucinations and leveraging multiple artificial intelligence models to improve operations. In addition to block 401, computing environment 400 includes, for example, sidekick AI 102, network 103, 107, such as a wide area network (WAN), end user device (EUD) 402, remote server 403, public cloud 404, and private cloud 405. In this embodiment, sidekick AI 102 includes processor set 406 (including processing circuitry 407 and cache 408), communication fabric 409, volatile memory 410, persistent storage 411 (including operating system 412 and block 401, as identified above), peripheral device set 413 (including user interface (UI) device set 414, storage 415, and Internet of Things (IoT) sensor set 416), and network module 417. Remote server 403 includes remote database 418. Public cloud 404 includes gateway 419, cloud orchestration module 420, host physical machine set 421, virtual machine set 422, and container set 423.

Sidekick AI 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 418. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically sidekick AI 102, to keep the presentation as simple as possible. Sidekick AI 102 may be located in a cloud, even though it is not shown in a cloud in FIG. 4. On the other hand, sidekick AI 102 is not required to be in a cloud except to any extent as may be affirmatively indicated.

Processor set 406 includes one, or more, computer processors of any type now known or to be developed in the future. Processing circuitry 407 may be distributed over multiple packages, for example, multiple, coordinated integrated circuit chips. Processing circuitry 407 may implement multiple processor threads and/or multiple processor cores. Cache 408 is memory that is located in the processor chip package(s) and is typically used for data or code that should be available for rapid access by the threads or cores running on processor set 406. Cache memories are typically organized into multiple levels depending upon relative proximity to the processing circuitry. Alternatively, some, or all, of the cache for the processor set may be located “off chip.” In some computing environments, processor set 406 may be designed for working with qubits and performing quantum computing.

Computer readable program instructions are typically loaded onto sidekick AI 102 to cause a series of operational steps to be performed by processor set 406 of sidekick AI 102 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 408 and the other storage media discussed below. The program instructions, and associated data, are accessed by processor set 406 to control and direct performance of the disclosed methods. In computing environment 400, at least some of the instructions for performing the disclosed methods may be stored in block 401 in persistent storage 411.

Communication fabric 409 is the signal conduction paths that allow the various components of sidekick AI 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 410 is any type of volatile memory now known or to be developed in the future. Examples include dynamic type random access memory (RAM) or static type RAM. Typically, the volatile memory is characterized by random access, but this is not required unless affirmatively indicated. In sidekick AI 102, the volatile memory 410 is located in a single package and is internal to sidekick AI 102, but, alternatively or additionally, the volatile memory may be distributed over multiple packages and/or located externally with respect to sidekick AI 102.

Persistent Storage 411 is any form of non-volatile storage for computers that is now known or to be developed in the future. The non-volatility of this storage means that the stored data is maintained regardless of whether power is being supplied to sidekick AI 102 and/or directly to persistent storage 411. Persistent storage 411 may be a read only memory (ROM), but typically at least a portion of the persistent storage allows writing of data, deletion of data and re-writing of data. Some familiar forms of persistent storage include magnetic disks and solid state storage devices. Operating system 412 may take several forms, such as various known proprietary operating systems or open source Portable Operating System Interface type operating systems that employ a kernel. The code included in block 401 typically includes at least some of the computer code involved in performing the disclosed methods.

Peripheral device set 413 includes the set of peripheral devices of sidekick AI 102. Data communication connections between the peripheral devices and the other components of sidekick AI 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 414 may include components such as a display screen, speaker, microphone, wearable devices (such as goggles and smart watches), keyboard, mouse, printer, touchpad, game controllers, and haptic devices. Storage 415 is external storage, such as an external hard drive, or insertable storage, such as an SD card. Storage 415 may be persistent and/or volatile. In some embodiments, storage 415 may take the form of a quantum computing storage device for storing data in the form of qubits. In embodiments where sidekick AI 102 is required to have a large amount of storage (for example, where sidekick AI 102 locally stores and manages a large database) then this storage may be provided by peripheral storage devices designed for storing very large amounts of data, such as a storage area network (SAN) that is shared by multiple, geographically distributed computers. IoT sensor set 416 is made up of sensors that can be used in Internet of Things applications. For example, one sensor may be a thermometer and another sensor may be a motion detector.

Network module 417 is the collection of computer software, hardware, and firmware that allows sidekick AI 102 to communicate with other computers through WAN 103, 107. Network module 417 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 417 are performed on the same physical hardware device. In other embodiments (for example, embodiments that utilize software-defined networking (SDN)), the control functions and the forwarding functions of network module 417 are performed on physically separate devices, such that the control functions manage several different network hardware devices. Computer readable program instructions for performing the disclosed methods can typically be downloaded to sidekick AI 102 from an external computer or external storage device through a network adapter card or network interface included in network module 417.

WAN 103, 107 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 402 is any computer system that is used and controlled by an end user (for example, a customer of an enterprise that operates sidekick AI 102), and may take any of the forms discussed above in connection with sidekick AI 102. EUD 402 typically receives helpful and useful data from the operations of sidekick AI 102. For example, in a hypothetical case where sidekick AI 102 is designed to provide a recommendation to an end user, this recommendation would typically be communicated from network module 417 of sidekick AI 102 through WAN 103, 107 to EUD 402. In this way, EUD 402 can display, or otherwise present, the recommendation to an end user. In some embodiments, EUD 402 may be a client device, such as thin client, heavy client, mainframe computer, desktop computer and so on.

Remote server 403 is any computer system that serves at least some data and/or functionality to sidekick AI 102. Remote server 403 may be controlled and used by the same entity that operates sidekick AI 102. Remote server 403 represents the machine(s) that collect and store helpful and useful data for use by other computers, such as sidekick AI 102. For example, in a hypothetical case where sidekick AI 102 is designed and programmed to provide a recommendation based on historical data, then this historical data may be provided to sidekick AI 102 from remote database 418 of remote server 403.

Public cloud 404 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 404 is performed by the computer hardware and/or software of cloud orchestration module 420. The computing resources provided by public cloud 404 are typically implemented by virtual computing environments that run on various computers making up the computers of host physical machine set 421, which is the universe of physical computers in and/or available to public cloud 404. The virtual computing environments (VCEs) typically take the form of virtual machines from virtual machine set 422 and/or containers from container set 423. It is understood that these VCEs may be stored as images and may be transferred among and between the various physical machine hosts, either as images or after instantiation of the VCE. Cloud orchestration module 420 manages the transfer and storage of images, deploys new instantiations of VCEs and manages active instantiations of VCE deployments. Gateway 419 is the collection of computer software, hardware, and firmware that allows public cloud 404 to communicate through WAN 103, 107.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 405 is similar to public cloud 404, except that the computing resources are only available for use by a single enterprise. While private cloud 405 is depicted as being in communication with WAN 103, 107 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 404 and private cloud 405 are both part of a larger hybrid cloud.

Block 401 further includes the software components discussed above in connection with FIGS. 2-3 to minimize AI hallucinations and leverage multiple artificial intelligence models to improve operations. In one embodiment, such components may be implemented in hardware. The functions discussed above performed by such components are not generic computer functions. As a result, sidekick AI 102 is a particular machine that is the result of implementing specific, non-generic computer functions.

In one embodiment, the functionality of such software components of sidekick AI 102, including the functionality for minimizing AI hallucinations and leveraging multiple artificial intelligence models to improve operations, may be embodied in an application specific integrated circuit.

As stated above, AI is implemented using AI models. An AI model is a program that analyzes datasets to find patterns and make predictions. That is, an AI model is a program or algorithm that relies on training data to recognize patterns and make predictions or decisions. Today, AI models are used in almost all industries. The complexity of the AI model used in a certain scenario will vary depending on the complexity of the task. Examples of tasks performed by AI models include face recognition, voice assistance, personalized shopping, writing, fraud prevention, and human resource management among many others. Unfortunately, at times, such AI models create outputs that are nonsensical or altogether inaccurate (e.g., claiming that the James Webb Space Telescope had captured the world's first images of a planet outside our solar system). Such a phenomenon is referred to as “AI hallucination,” where a large language model (LLM)—often a generative AI chatbot or computer vision tool—perceives patterns or objects that are nonexistent or imperceptible to human observers, creating outputs that are nonsensical or altogether inaccurate. Generally, if a user makes a request of a generative AI tool, they desire an output that appropriately addresses the prompt (i.e., a correct answer to a question). However, sometimes AI algorithms produce outputs that are not based on training data, are incorrectly decoded by the transformer, or do not follow any identifiable pattern. In other words, it “hallucinates” the response. AI hallucinations may occur due to various factors, including overfitting, training data bias/inaccuracy, and high model complexity. Unfortunately, there is not currently a means for effectively limiting such misrepresentations.

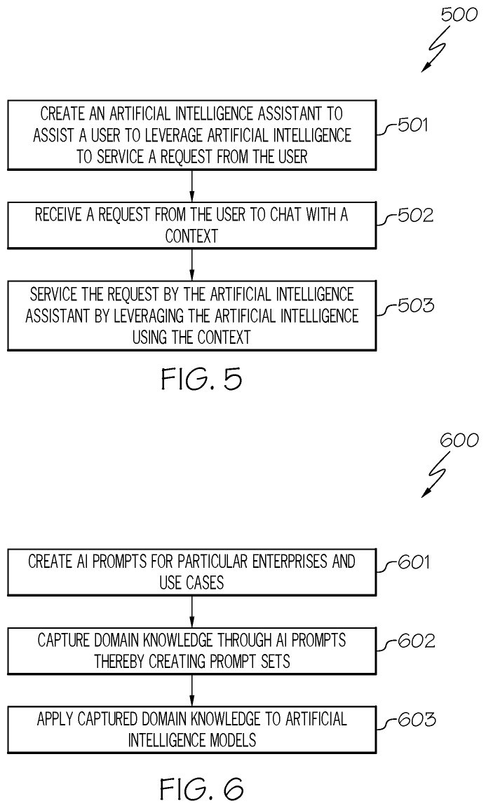

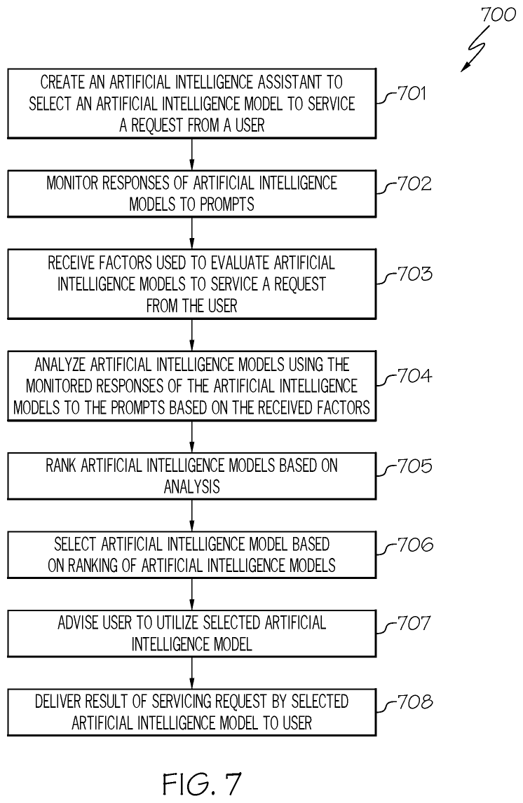

The embodiments of the present disclosure provide a means for minimizing AI hallucinations and leveraging the innovation in the development and improvement of artificial intelligence models to select the most suitable artificial intelligence model to service the needs of the user as discussed below in connection with FIGS. 5-7. FIG. 5 is a flowchart of a method for minimizing AI hallucinations. FIG. 6 is a flowchart of a method for delivering targeted artificial intelligence solutions across a variety of use cases. FIG. 7 is a flowchart of a method for leveraging multiple artificial intelligence models to improve operations.

As stated above, FIG. 5 is a flowchart of a method 500 for minimizing AI hallucinations in accordance with an embodiment of the present disclosure.

Referring to FIG. 5, in conjunction with FIGS. 1-4, in step 501, artificial intelligence assistant engine 303 of sidekick AI 102 creates an artificial intelligence assistant to assist a user (e.g., user of client 101) to leverage artificial intelligence to service a request from the user. An artificial intelligence assistant, as used herein, refers to a application program that understands natural language voice commands and completes tasks for the user.

As stated above, in one embodiment, such an artificial intelligence assistant is used to service the request from the user by leveraging the artificial intelligence using context. Context, as used herein, refers to items that enable experiences that are utilized by the user for interacting (e.g., chatting) with artificial intelligence, which is used to minimize artificial intelligence hallucinations since such context is used by the artificial intelligence model to output a response thereby providing more confidence that the output response of the artificial intelligence model is more accurate. Examples of context include, but are not limited to, an artificial intelligence model, a task-specific assistant (pre-instruct an artificial intelligence model to elicit a type of response), a document (e.g., ChatDOC), a data source, a conversation, an image, an intermediary, etc. By introducing such context, there is a greater confidence that the output of the artificial intelligence model is more accurate.

In one embodiment, AI assistant engine 303 creates an artificial intelligence assistant by selecting a base model, developing prompts, and integrating AI history. The base model serves as the foundation for the artificial intelligence assistant and determines its core capabilities. In one embodiment, a list of various base models associated with objectives and tasks to be performed is stored in a data structure (e.g., table), which may reside within the storage device (e.g., storage device 411, 415) of sidekick AI 102. Based on identifying the objectives and tasks to be performed, which may be provided by the user (e.g., user of client 101), AI assistant engine 303 identifies the appropriate base model from the data structure discussed above. In one embodiment, such a data structure is populated by an expert.

In one embodiment, prompts guide the artificial intelligence assistant's interactions with users. Such prompts are designed to elicit meaningful responses from the artificial intelligence assistant. In one embodiment, such prompts are generated by generating engine 301 as discussed above. For example, generating engine 301 may utilize an AI prompt generator tool to suggest AI prompts based on inputs provided by generating engine 301. In one embodiment, such inputs correspond to categories of knowledge (e.g., theory of relativity), which are used by the AI prompt generator to generate AI prompts. In one embodiment, such categories of knowledge are extracted by generating engine 301 from a data structure (e.g., table) that includes a listing of the categories of knowledge and corresponding enterprises and use cases. Based on the identification of an enterprise or use case received by generating engine 301, generating engine 301 uses such an identification to identify the corresponding category of knowledge in the data structure. In one embodiment, such a data structure resides within the storage device (e.g., storage device 411, 415) of sidekick AI 102. In one embodiment, such a data structure is populated by an expert.

In step 502, sidekick AI 102 receives a request from the user (e.g., user of client 101), such as a request to chat with a context. That is, sidekick AI 102 receives a request from the user to participate in a chat experience.

As discussed above, in one embodiment, sidekick AI 102 introduces versatile chat experiences which provide context for minimizing artificial intelligence hallucinations. For example, one such chat experience involves chatting with an artificial intelligence model out of the artificial intelligence models stored in database 104. As discussed above, sidekick AI 102 offers default access to watsonx.ai models. Furthermore, sidekick AI 102 allows engagement with third-party and ecosystem models. Such flexibility enables access to both wastonx.ai models and other specialized models as the client needs dictate.

In another example, a chat experience may involve chatting with task-specific assistants. As previously discussed, such task-specific assistants pre-instruct an artificial intelligence model to elicit a type of response. For example, the assistant may pre-instruct an artificial intelligence model out of the artificial intelligence models stored in database 104 to automatically provide the weather forecast for the next four hours in the city of Yorktown Heights. Such task-specific assistants provide a chat experience tailored to specific tasks, roles, or outcomes. For instance, a design chat-assistant ensures that the responses align with company guidelines; whereas, a code-review assistant may follow team-specific coding standards.

In a further example, a chat experience may involve chatting with documents. For instance, sidekick AI 102 may use the retrieval augmented generation (RAG) technique to compile document collections (e.g., PDFs, DOCs, etc.) for focused chat sessions. These collections can summarize presentations, technical papers, and requirements. The scope of such collections may be user-specific, team-specific, or contributed to a global repository for organizational use. In one embodiment, such a chat experience with documents enables users to quickly extract, locate, and summarize information, such as via ChatDOC.

In another example, a chat experience may involve chatting with data sources. Such a feature includes the ability to chat with various Internet and Intranet content, ranging from weather and stock market feeds to Google® search and Wikipeida® through application programming interfaces.

Other examples of context (chat experience) include a previous conversation, an intermediary (e.g., virtual assistant), etc.

In step 503, the request from the user is then serviced by the artificial intelligence assistant by leveraging the artificial intelligence (e.g., artificial intelligence models stored in database 104) using the context. By introducing such context, there is a greater confidence that the output of the artificial intelligence model is more accurate.

Such leveraged artificial intelligence may consist of the artificial intelligence models stored in database 104, which may be used for delivering targeted artificial intelligence solutions across a variety of use cases as discussed below in connection with FIG. 6.

As stated above, FIG. 6 is a flowchart of a method 600 for delivering targeted artificial intelligence solutions across a variety of use cases in accordance with an embodiment of the present disclosure.

Referring to FIG. 6, in conjunction with FIGS. 1-5, in step 601, generating engine 301 of sidekick AI 102 creates AI prompts for particular enterprises and use cases. A “prompt” (also referred to herein as an “AI prompt”), as used herein, refers to a mode of interaction between a human and a large language model that lets the model generate the intended output. The interaction may be in the form of a question, text, code snippets, or examples.

As discussed above, in one embodiment, generating engine 301 receives an identification of the enterprise or use case for which to create an AI prompt from the user of sidekick AI 102. In one embodiment, generating engine 301 utilizes an AI prompt generator tool to suggest AI prompts based on inputs provided by generating engine 301. In one embodiment, such inputs correspond to categories of knowledge (e.g., theory of relativity), which are used by the AI prompt generator to generate AI prompts. In one embodiment, such categories of knowledge are extracted by generating engine 301 from a data structure (e.g., table) that includes a listing of the categories of knowledge and corresponding enterprises and use cases. Based on the identification of an enterprise or use case received by generating engine 301, generating engine 301 uses such an identification to identify the corresponding category of knowledge in the data structure. In one embodiment, such a data structure resides within the storage device (e.g., storage device 411, 415) of sidekick AI 102. In one embodiment, such a data structure is populated by an expert.

In one embodiment, generating engine 301 may utilizes various AI prompt generator tools to create AI prompts for particular enterprises and use cases, which may include, but are not limited to, AI Prompt Generator, PromtoMania, PromptPerfect, PromptHero, PromptBase, etc.

In step 602, capturing engine 302 of sidekick AI 102 captures domain knowledge through AI prompts thereby creating prompt sets. Domain knowledge, as used herein, refers to the knowledge of a specific, specialized discipline or field. A “prompt set,” as used herein, refers to a ready-made, test, and optimized prompt designed to perform specific tasks. For instance, a prompt set may correspond to a collection of domain knowledge and a prompt. An example of a prompt set may include the prompt of explaining how the theory of relativity works as well as the data to answer such a prompt.

As stated above, in one embodiment, capturing engine 302 performs a search in external systems 106, such as via network 107, which contain domain knowledge. External systems 106, as used herein, refer to any system that is external to sidekick AI 102 which may include the storage of domain knowledge. In one embodiment, such a search is performed in external systems 106 by utilizing a search engine (e.g., Google®, Openverse®, Bing®, Yahoo®, etc.) based on the AI prompt (e.g., how does the theory of relativity work).

In one embodiment, such domain knowledge that is identified via the search engine is captured and appended to the appropriate AI prompt. The captured domain knowledge and the associated AI prompt are combined to form the prompt set, which is stored in database 108.

In one embodiment, the search engine utilized by capturing engine 302 includes a spider (program run by the search engine) to build a summary of a website's content. Spiders create a text-based summary of content and an address (URL) for each webpage. In one embodiment, based on the text-based summary of the content, the search engine and/or capturing engine 302 uses natural language processing to determine if the text-based summary of the content of the webpage is pertinent to the AI prompt (e.g., how does the theory of relativity work). If the text-based summary of the content of the webpage is pertinent to the AI prompt, then the content of the webpage is captured as domain knowledge.

In one embodiment, such a determination is performed based on evaluating the similarity of the AI prompt to the text-based summary of the content of the webpage. In one embodiment, such similarity between the text-based summary of the content of the webpage and the AI prompt is determined by vectorizing the text-based summary of the content of the webpage and the AI prompt, such as via Word2vec, Doc2Vec, GloVe, etc. After being converted into real-valued vectors, a similarity measure, such as cosine similarity or the Euclidean distance, may be used to determine the similarity between the text-based summary of the content of the webpage and the AI prompt. Such a similarity measure is compared to a threshold value, which may be user-designated, to determine if the text-based summary of the content of the webpage is within a threshold degree of similarity, which may be user-designated, to the AI prompt. If the similarity measure exceeds such a threshold value, then the text-based summary of the content of the webpage and the AI prompt are deemed to be within a threshold degree of similarity and the content of the webpage is captured as domain knowledge. Otherwise, the text-based summary of the content of the webpage and the AI prompt are not deemed to be within the threshold degree of similarity and the content of the webpage is not captured as domain knowledge.

“Cosine similarity,” as used herein, refers to a measure of similarity between two non-zero vectors defined in an inner product space. Cosine similarity is the cosine of the angle between the vectors. That is, it is the dot product of the vectors divided by the product of their lengths. If the measurement exceeds a threshold value, which may be user-designated, then the text-based summary of the content of the webpage and the AI prompt are deemed to be within a threshold degree of similarity and the content of the webpage is captured as domain knowledge. Otherwise, the text-based summary of the content of the webpage and the AI prompt are not deemed to be within the threshold degree of similarity and the content of the webpage is not captured as domain knowledge.

In one embodiment, the Euclidean distance is calculated as the square root of the sum of the squared differences between the two feature vectors. If the distance exceeds a threshold value, which may be user-designated, then the text-based summary of the content of the webpage and the AI prompt are deemed to be within a threshold degree of similarity and the content of the webpage is captured as domain knowledge. Otherwise, the text-based summary of the content of the webpage and the AI prompt are not deemed to be within the threshold degree of similarity and the content of the webpage is not captured as domain knowledge.

In one embodiment, the similarity measure is a score between the values of 0 and 1 for vectors that have only positive values. In one embodiment, any negative scores can be made positive by taking its absolute value.

Capturing engine 302 utilizes various software tools for generating the similarity score, which can include, but are not limited to, TensorFlow®, Math Works®, plus sklearn, scikit-Learn®, etc.

In step 603, capturing engine 302 of sidekick AI 102 applies the captured domain knowledge to the artificial intelligence models, such as the artificial intelligence models stored in database 104.

As discussed above, in one embodiment, such captured domain knowledge is applied to the artificial intelligence models to ensure that such artificial intelligence models recognize patterns and make predictions or decisions utilizing such domain knowledge in order to deliver targeted artificial intelligence solutions across a variety of use cases.

In one embodiment, “applying” involves training and evaluating the artificial intelligence models using such captured domain knowledge. In one embodiment, such captured domain knowledge corresponds to problem-specific information that can change the input data, the loss-function, or the parameters.

By applying the captured domain knowledge to the artificial intelligence models, such models leverage the latest available knowledge. Furthermore, the artificial intelligence models that are stored in database 104 are constantly updated to ensure that the latest development and improvement of artificial intelligence models are reflected in the artificial intelligence models stored in database 104. Hence, the latest developed and improved artificial intelligence models stored in database 104 can leverage the latest available domain knowledge.

A discussion regarding leveraging such artificial intelligence models to improve operations is provided below in connection with FIG. 7.

FIG. 7 is a flowchart of a method 700 for leveraging multiple artificial intelligence models to improve operations in accordance with an embodiment of the present disclosure.

Referring to FIG. 7, in conjunction with FIGS. 1-6, in step 701, artificial intelligence assistant engine 303 of sidekick AI 102 creates an artificial intelligence assistant to select an artificial intelligence model to service a request from a user (e.g., user of client 101). An artificial intelligence assistant, as used herein, refers to a application program that understands natural language voice commands and completes tasks for the user.

As stated above, in one embodiment, such an artificial intelligence assistant is used to select an artificial intelligence model that best services a request from the user after the artificial intelligence models stored in database 104 have been ranked based, at least in part, on the factors provided by the user (e.g., user of client 101) as discussed herein.

In one embodiment, AI assistant engine 303 creates an artificial intelligence assistant by selecting a base model, developing prompts, and integrating AI history. The base model serves as the foundation for the artificial intelligence assistant and determines its core capabilities. In one embodiment, a list of various base models associated with objectives and tasks to be performed is stored in a data structure (e.g., table), which may reside within the storage device (e.g., storage device 411, 415) of sidekick AI 102. Based on identifying the objectives and tasks to be performed, which may be provided by the user (e.g., user of client 101), AI assistant engine 303 identifies the appropriate base model from the data structure discussed above. In one embodiment, such a data structure is populated by an expert.

In one embodiment, prompts guide the artificial intelligence assistant's interactions with users. Such prompts are designed to elicit meaningful responses from the artificial intelligence assistant. In one embodiment, such prompts are generated by generating engine 301 as discussed above. For example, generating engine 301 may utilize an AI prompt generator tool to suggest AI prompts based on inputs provided by generating engine 301. In one embodiment, such inputs correspond to categories of knowledge (e.g., theory of relativity), which are used by the AI prompt generator to generate AI prompts. In one embodiment, such categories of knowledge are extracted by generating engine 301 from a data structure (e.g., table) that includes a listing of the categories of knowledge and corresponding enterprises and use cases. Based on the identification of an enterprise or use case received by generating engine 301, generating engine 301 uses such an identification to identify the corresponding category of knowledge in the data structure. In one embodiment, such a data structure resides within the storage device (e.g., storage device 411, 415) of sidekick AI 102. In one embodiment, such a data structure is populated by an expert.

In one embodiment, AI assistant engine 303 integrates AI history and context sources, which may be stored in database 104, 108. In one embodiment, such sources form the knowledge base of the artificial intelligence assistant, providing it with vital background information, thereby enhancing the artificial intelligence assistant's ability to respond effectively.

In step 702, monitoring engine 304 of sidekick AI 102 monitors the response of the artificial intelligence models stored in database 104 to prompts.

As discussed above, in one embodiment, such prompts correspond to the prompts of the prompt sets stored in database 108. In one embodiment, such artificial intelligence models stored in database 104 correspond to the latest developed and improved artificial intelligence models that can leverage the latest available domain knowledge.

In one embodiment, monitoring engine 304 monitors the response of the artificial intelligence models stored in database 104 to prompts based on tracking metrics, such as accuracy, precision, recall, and F1-score, to evaluate the model performance. By monitoring or tracking such metrics, changes in the model behavior, potential drift, or degradation in performance can be detected.

In one embodiment, monitoring engine 304 monitors the response of the artificial intelligence models stored in database 104 to prompts by tracking data distribution shifts, performance shifts, system performance (e.g., usage of CPU, memory, disk, and network I/O), performance by segment (allows one to find critical areas, such as where the machine learning model makes mistakes and where it performs the best), bias/fairness (ensuring that all sub-groups and track compliances have received fair treatment), etc.

In one embodiment, monitoring engine 304 utilizes various software tools for monitoring the response of the artificial intelligence models stored in database 104 to prompts (e.g., prompt of explaining how the theory of relativity works), such as, but are not limited to, Lakehouse Monitoring, Valohai, MetricFire®, Qwak, etc.

In step 703, benchmark engine 305 of sidekick AI 102 receives factors from a user, such as the user of client 101, which are used to evaluate the artificial intelligence models stored in database 104 to service a request from the user.

As stated above, examples of such a request include, but are not limited to, identifying opportunities for services, optimizing the structure of a complex service system, optimizing the operation of a service system, identifying an operational risk, identifying a fault, identifying a potential causality, etc.

In one embodiment, such factors provided by the user (e.g., enterprise, individual) correspond to important metrics that need to be minimized or maximized. Examples of metrics include cost, privacy, bias, and a user's role. Cost, as used herein, refers to the total cost of implementing the artificial intelligence model to service the user's request, including the hardware cost (e.g., computational power, data storage, etc.) as well as the software cost (e.g., analysis, processing, etc.) for running the artificial intelligence algorithm. In one embodiment, such information for servicing various requests is stored in a data structure (e.g., table) residing within the storage device (e.g., storage device 411, 415) of sidekick AI 102. In one embodiment, in addition to providing the factors, the user provides benchmark engine 305 the request to be serviced. Upon receipt of the request to be serviced, benchmark engine 305 identifies cost information stored in the data structure discussed above that is associated with such a request. In one embodiment, such a data structure is populated by an expert.

Privacy, as used herein, refers to the risk of data leakage. In one embodiment, benchmark engine 305 evaluates the risk of data leakage for each artificial intelligence model using a privacy impact assessment. In one embodiment, such an assessment is performed by using a privacy loss parameter that is used to measure how much an output changes when data is added or removed.

In one embodiment, benchmark engine 305 determines the probability of data leakage in the artificial intelligence model based on the Bayesian inference to produce a thorough approach to calculate the reverse probability of unseen variables in order to make statistical conclusions about the relevant correlated variables and to calculate accordingly a lower limit on the marginal likelihood of the observed variables being derived from a coupling method. A higher marginal probability for a set of variables suggests a better fit of the data and thus a greater likelihood of a data leak in the artificial intelligence model.

Bias, as used herein, refers to erroneous assumptions in the machine learning process that produce erroneous results. In one embodiment, benchmark engine 305 detects bias for each artificial intelligence model stored in database 104 by looking at the disparate impact of model outcome across different population subsets. Benchmark engine 305 may utilize various software tools for detecting bias including, but are not limited to, Audit AI, AI Fairness 360, Skater, etc.

The user's role, as used herein, refers to a predefined category that is assigned to users based on various criteria, which may be established by sidekick AI 102. Examples of such roles include data service, environment maker, basic user, system administrator, etc. In one embodiment, the user determines its role from a catalog of roles provided by sidekick AI 102, such as via a drop-down menu. In one embodiment, the user (e.g., user of client 101) makes a selection of its role via the graphical user interface of client 101.

In step 704, benchmark engine 305 of sidekick AI 102 analyzes the artificial intelligence models stored in database 104 using the monitored responses of the artificial intelligence models to the prompts based on the received factors.

As discussed above, in one embodiment, based on the monitored responses of the artificial intelligence models to the prompts, such monitored responses of the artificial intelligence models are compared to metrics established by the received factors. For example, the responses of the artificial intelligence models concerning system performance (e.g., usage of CPU, memory, disk, and network I/O) may be compared amongst each other by benchmark engine 305 to determine which has a cost advantage (i.e., which artificial intelligence model has the lowest cost in terms of system usage). In another example, the responses of the artificial intelligence models concerning system performance may be evaluated by benchmark engine 305 based on detecting bias by looking at the disparate impact of model outcome across different population subsets. In another example, the responses of the artificial intelligence models concerning the risk of data leakage may be evaluated by benchmark engine 305 based on implementing a privacy impact assessment, such as by using a privacy loss parameter to measure how much an output changes when data is added or removed.

In another example, the artificial intelligence models stored in database 104 may be analyzed based on the user's role, In one embodiment, certain artificial intelligence models are better able to service certain roles than other artificial intelligence models. In one embodiment, the ability of certain artificial intelligence models, such as the artificial intelligence models stored in database 104, to service various roles is identified from a data structure (e.g., table), which may reside within the storage device (e.g., storage device 411, 415) of sidekick AI 102. In one embodiment, such abilities to service various roles are identified from the data structure by benchmark engine 305 based on values associated with the role and corresponding artificial intelligence model. In one embodiment, the higher the value, the greater the ability of the artificial intelligence model to service such a role and vice-versa. In one embodiment, such a data structure is populated by an expert.

In step 705, benchmark engine 305 of sidekick AI 102 ranks the artificial intelligence models stored in database 104 based on the analysis, such as ranking the artificial intelligence models from being the best performer in terms of satisfying the factors provided by the user to the greatest extent (e.g., minimizing the cost, maximizing privacy, minimizing bias, etc.).

As stated above, in one embodiment, benchmark engine 305 ranks the artificial intelligence models in terms of satisfying the factors provided by the user to the greatest extent using various software tools including, but are not limited to, Fiddler®, Arize®, Amazon SageMaker®, etc.

In step 706, upon ranking the artificial intelligence models that are stored in database 104 in terms of satisfying the factors provided by the user to the greatest extent, the artificial intelligence assistant discussed above selects the artificial intelligence model that is ranked the highest.

In step 707, the artificial intelligence assistant advises the user (e.g., user of client 101) to utilize the selected artificial intelligence model to service the request.

As discussed above, in one embodiment, the artificial intelligence assistant may advise the user via the graphical user interface of client 101.

In one embodiment, the user may be prompted via the graphical user interface of client 101 as to whether the user agrees to utilize the selected artificial intelligence model. For example, graphical representations (e.g., yes or no buttons) may be presented to the user on the graphical user interface of client 101.

If the user indicates to utilize the selected artificial intelligence model (e.g., user selects the yes button on the graphical user interface of client 101), then, in one embodiment, the artificial intelligence assistant has the selected artificial intelligence model service the user's request upon receipt of the user's request, which may be received directly from the user or from benchmark engine 305.

In step 708, upon servicing the user's request by the selected artificial intelligence model, the artificial intelligence assistant delivers the result of servicing the request by the selected artificial intelligence model to the user.

In this manner, artificial intelligence hallucinations are minimized by introducing context (e.g., task-specific assistant) to improve the output accuracy of the artificial intelligence model. Furthermore, in this manner, the most suitable artificial intelligence model to service the needs of the user is selected by leveraging the innovation in the development and improvement of artificial intelligence models and continuously capturing domain knowledge, such as through prompt sets for particular enterprises and use cases, that are applied to such artificial intelligence models.

Furthermore, the principles of the present disclosure improve the technology or technical field involving artificial intelligence models.

As discussed above, AI is implemented using AI models. An AI model is a program that analyzes datasets to find patterns and make predictions. That is, an AI model is a program or algorithm that relies on training data to recognize patterns and make predictions or decisions. Today, AI models are used in almost all industries. The complexity of the AI model used in a certain scenario will vary depending on the complexity of the task. Examples of tasks performed by AI models include face recognition, voice assistance, personalized shopping, writing, fraud prevention, and human resource management among many others. Unfortunately, at times, such AI models create outputs that are nonsensical or altogether inaccurate (e.g., claiming that the James Webb Space Telescope had captured the world's first images of a planet outside our solar system). Such a phenomenon is referred to as “AI hallucination,” where a large language model (LLM)—often a generative AI chatbot or computer vision tool—perceives patterns or objects that are nonexistent or imperceptible to human observers, creating outputs that are nonsensical or altogether inaccurate. Generally, if a user makes a request of a generative AI tool, they desire an output that appropriately addresses the prompt (i.e., a correct answer to a question). However, sometimes AI algorithms produce outputs that are not based on training data, are incorrectly decoded by the transformer, or do not follow any identifiable pattern. In other words, it “hallucinates” the response. AI hallucinations may occur due to various factors, including overfitting, training data bias/inaccuracy, and high model complexity. Unfortunately, there is not currently a means for effectively limiting such misrepresentations.

Embodiments of the present disclosure improve such technology by creating an artificial intelligence assistant to assist a user in leveraging artificial intelligence to service a request from a user. An artificial intelligence assistant, as used herein, refers to a application program that understands natural language voice commands and completes tasks for the user. Furthermore, a request is received from the user, where the request is a request to chat with a context. Context, as used herein, refers to items that enable experiences that are utilized by the user for interacting (e.g., chatting) with artificial intelligence, which is used to minimize artificial intelligence hallucinations since such context is used by the artificial intelligence model to output a response thereby providing more confidence that the output response of the artificial intelligence model is more accurate. Examples of context include, but are not limited to, an artificial intelligence model, a task-specific assistant (pre-instruct an artificial intelligence model to elicit a type of response), a document (e.g., ChatDOC), a data source, a conversation, etc. The request is then serviced by leveraging the artificial intelligence using the context. In this manner, artificial intelligence hallucinations are minimized. Furthermore, in this manner, there is an improvement in the technical field involving artificial intelligence models.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for leveraging artificial intelligence to improve operations, the method comprising:
creating an artificial intelligence assistant to assist a user in leveraging artificial intelligence;
receiving a request from said user to chat with a context, wherein said context comprises items that enable experiences that are utilized by said user for interacting with said artificial intelligence; and
servicing said request from said user by said artificial intelligence assistant by leveraging said artificial intelligence using said context.

2. The method as recited in claim 1, wherein said context comprises one or more of the following in the group consisting of: an artificial intelligence model, a task-specific assistant, a document, a document source, a conversation, an image, and an intermediary.

3. The method as recited in claim 1, wherein said artificial intelligence is leveraged based on a plurality of artificial intelligence models, wherein the method further comprises:
receiving factors used to evaluate said plurality of artificial intelligence models to service said request from said user;
analyzing said plurality of artificial intelligence models based on said received factors;
ranking said plurality of artificial intelligence models based on said analysis; and
selecting said artificial intelligence model out of said plurality of artificial intelligence models by said artificial intelligence assistant based on said ranking of said plurality of artificial intelligence models.

4. The method as recited in claim 3 further comprising:
advising said user to utilize said selected artificial intelligence model to service said request.

5. The method as recited in claim 4 further comprising:
delivering a result of servicing said request by said selected artificial intelligence model to said user.

6. The method as recited in claim 3 further comprising:
monitoring responses of said plurality of artificial intelligence models to prompts; and
analyzing said plurality of artificial intelligence models using said monitored responses of said plurality of artificial intelligence models to prompts based on said received factors.

7. The method as recited in claim 1 further comprising:
creating artificial intelligence prompts for particular enterprises and/or use cases;
capturing domain knowledge through said artificial intelligence prompts; and
applying said captured domain knowledge to a plurality of artificial intelligence models.

8. A computer program product for leveraging artificial intelligence to improve operations, the computer program product comprising one or more computer readable storage mediums having program code embodied therewith, the program code comprising programming instructions for:
creating an artificial intelligence assistant to assist a user in leveraging artificial intelligence;
receiving a request from said user to chat with a context, wherein said context comprises items that enable experiences that are utilized by said user for interacting with said artificial intelligence; and
servicing said request from said user by said artificial intelligence assistant by leveraging said artificial intelligence using said context.

9. The computer program product as recited in claim 8, wherein said context comprises one or more of the following in the group consisting of: an artificial intelligence model, a task-specific assistant, a document, a document source, a conversation, an image, and an intermediary.

10. The computer program product as recited in claim 8, wherein said artificial intelligence is leveraged based on a plurality of artificial intelligence models, wherein the program code further comprises the programming instructions for:
receiving factors used to evaluate said plurality of artificial intelligence models to service said request from said user;
analyzing said plurality of artificial intelligence models based on said received factors;
ranking said plurality of artificial intelligence models based on said analysis; and
selecting said artificial intelligence model out of said plurality of artificial intelligence models by said artificial intelligence assistant based on said ranking of said plurality of artificial intelligence models.

11. The computer program product as recited in claim 10, wherein the program code further comprises the programming instructions for:
advising said user to utilize said selected artificial intelligence model to service said request.

12. The computer program product as recited in claim 11, wherein the program code further comprises the programming instructions for:
delivering a result of servicing said request by said selected artificial intelligence model to said user.

13. The computer program product as recited in claim 10, wherein the program code further comprises the programming instructions for:
monitoring responses of said plurality of artificial intelligence models to prompts; and
analyzing said plurality of artificial intelligence models using said monitored responses of said plurality of artificial intelligence models to prompts based on said received factors.

14. The computer program product as recited in claim 8, wherein the program code further comprises the programming instructions for:
creating artificial intelligence prompts for particular enterprises and/or use cases;
capturing domain knowledge through said artificial intelligence prompts; and
applying said captured domain knowledge to a plurality of artificial intelligence models.

15. A system, comprising:
a memory for storing a computer program for leveraging artificial intelligence to improve operations; and
a processor connected to the memory, wherein the processor is configured to execute program instructions of the computer program comprising:
creating an artificial intelligence assistant to assist a user in leveraging artificial intelligence;
receiving a request from said user to chat with a context, wherein said context comprises items that enable experiences that are utilized by said user for interacting with said artificial intelligence; and
servicing said request from said user by said artificial intelligence assistant by leveraging said artificial intelligence using said context.

16. The system as recited in claim 15, wherein said context comprises one or more of the following in the group consisting of: an artificial intelligence model, a task-specific assistant, a document, a document source, a conversation, an image, and an intermediary.

17. The system as recited in claim 15, wherein said artificial intelligence is leveraged based on a plurality of artificial intelligence models, wherein the program instructions of the computer program further comprise:
receiving factors used to evaluate said plurality of artificial intelligence models to service said request from said user;
analyzing said plurality of artificial intelligence models based on said received factors;
ranking said plurality of artificial intelligence models based on said analysis; and
selecting said artificial intelligence model out of said plurality of artificial intelligence models by said artificial intelligence assistant based on said ranking of said plurality of artificial intelligence models.

18. The system as recited in claim 17, wherein the program instructions of the computer program further comprise:
advising said user to utilize said selected artificial intelligence model to service said request.

19. The system as recited in claim 18, wherein the program instructions of the computer program further comprise:
delivering a result of servicing said request by said selected artificial intelligence model to said user.

20. The system as recited in claim 17, wherein the program instructions of the computer program further comprise:
monitoring responses of said plurality of artificial intelligence models to prompts; and
analyzing said plurality of artificial intelligence models using said monitored responses of said plurality of artificial intelligence models to prompts based on said received factors.
